(19) United States
(12) Patent Application Publication
(10) Pub. No.: US 2026/0252361 A1
(43) Pub. Date: Aug. 27, 2026

(54) SYSTEMS AND METHODS FOR MANAGING AND CONTROLLING MULTI-CPU ENVIRONMENTS WITHOUT A SHARED CLOCK SOURCE OR VARYING CPU FREQUENCIES

(71) Applicant: Raptor Engineering, LLC, Poplar Grove, IL (US)

(72) Inventor: Timothy Raymond Pearson, Boone, IL (US)

(73) Assignee: Raptor Engineering, LLC, Poplar Grove, IL (US)

(21) Appl. No.: 19/533,657

(22) Filed: Feb. 9, 2026

Related U.S. Application Data
(60) Provisional application No. 63/761,705, filed on Feb. 21, 2025.

(51) Int. Cl. G06F 9/4401; G06F 9/54; G06F 11/14

(52) U.S. Cl. CPC G06F 9/4405; G06F 9/544; G06F 11/1407

(57) ABSTRACT

Secure lockstep execution and automatic detection errors, and the ability to add new CPUs to a system while the system remains online. At its most basic level, high-reliability lockstep execution can be viewed as a process by which one or more CPUs execute the same instructions, operating on the same data, and where a relatively simple logic system can reliably and rapidly detect divergence of execution in one or more of the monitored CPUs.

### BACKGROUND INFORMATION

### Field of the Disclosure

Examples of the present disclosure are related to systems and methods for managing and controlling computers securely without the computers utilizing a shared clock source or varying CPU frequencies. More specifically, embodiments utilize a series of checkpoints at known points in program execution, wherein a monitoring system performs a comparison of encrypted state data at the checkpoints to determine if a CPU’s state is identical across multiple CPUs within the system .

### Background

Equipment redundancy is a reliability engineering technique that helps a system to perform without interruption even when a piece of equipment fails. Systems need help from many redundant components, including redundant CPUs. In particular, systems must be designed so that no single hardware or software fault can disrupt the operation of the entire system. These critical infrastructure designs normally incorporate multiple electrical, mechanical, and physical redundancies designed to allow non-stop operation even during partial system failures or planned maintenance.

However, due to deficiencies in available CPU technologies, there is no equivalent redundancy for the overall system including the system processing logic. This results in a requirement for unwanted scheduled outages, or an overall system failure risk should the processing logic malfunction. As an example, if a transient memory fault causes a reset of a CPU controlling a critical process such as chilled fluid generation or distribution system, the reset may cause a disruptive outage with a non-bypassable delay for physical pumps, compressors etc. to unlock, restart, and the affected cooling loops to come back online. This delay can cause a cascading service disruption due to the affected equipment overheating.

Currently, for redundancy, systems utilize lockstep redundancy that uses multiple identical processors to run the same instructions in parallel. These systems require the CPUs to be running identical operations at the same time utilizing a shared clock. The processors compare their results at each step to detect errors. If the results don’t match, the mismatched CPU may be taken offline. Yet, if a CPU is required to be taken offline it is not possible to update the offline CPU, and reintegrate the CPU back into the system while the system is live because these systems require both a shared clock and must share identical internal state at each clock cycle. Since there is no way to securely transfer the complex and timing-dependent internal state to a new CPU, this can lead to significant downtime.

Accordingly, needs exist for central processing unit (CPU) cores that are capable of executing the same instructions as each other in the absence of a shared clock source or where varying CPU frequencies are utilized, wherein checkpoint transmissions at known points in the program executions are utilized to compare the state of the CPUs.

### SUMMARY

Examples of the present disclosure are related to systems and methods for secure lockstep execution and automatic detection of errors, and the ability to add new CPUs to the system while the system remains online. At its most basic level, high-reliability lockstep execution of program or code can be viewed as a process by which one or more CPUs execute the same instructions, operating on the same data, and where a relatively simple logic system can reliably and rapidly detect divergence of execution in one or more of the monitored CPUs. Embodiments may apply to any set of CPU cores that are capable of executing the same instructions as one another without a shared, phase-matched clock, although a shared master clock source or derivative clock tree may still be utilized in embodiments for the convenience of system board implementation. Specific embodiments may utilize at least three parallel CPUs to tie-break any detected faults, wherein the CPUs utilize a series of checkpoint transmissions at known points in program execution.

Embodiments may include shared resources, a plurality of CPUs, and monitor system logic.

The shared resources may be computing resources that may be allocated and used by each of the CPUs. For example, the shared resources may include RAM, programs, data, file access, storage devices, peripherals, etc. In embodiments, each CPU may access shared resources without requiring an exclusive lock on the shared resource.

Each of the CPUs may be a primary processor for a given computer and is configured to execute instructions of a computer program, such as arithmetic, logic, controlling, I/O operations, etc. The instructions may have embedded checkpoints, which trigger a series of events to detect errors and allow for new CPUs to be integrated into a multi-CPU environment and/ or failed CPUs to be automatically removed.

Each of the CPUs is associated with a planar, which provides basic support logic, I/O channels, memory access, and power to the CPU. Each CPU may have their own independent clock that regulates the timing and speed of all computer functions. In embodiments, more than one CPU may be present on a planar. While executing the instructions utilizing their independent clocks, each of the CPUs may have a state change that refers to how and where the computer program stores data in variables, which represent storage locations in the CPU's memory. The content of these memory locations, at any given point in the program's execution, are called the CPU's state.

In operation, the CPUs may be impacted by a change in the CPUs state that is triggered by an external event or input, i.e. something outside of the system itself that caused the state change. For example, a user pressing a key on a keyboard, receiving data over a network, or a sensor detecting a change. When each of the CPUs is executing in parallel utilizing the same clock, each of the CPU’s states should be identical at the same instance of time due to a shared clock. On the other hand, in embodiments, because the CPUs run asynchronously with their independent clocks, the state of each of the CPUs may drift apart and be different from each other at an instance in time because each of the CPUs may run the program, code, instructions, etc. at a different instance of time. However, because each of the CPUs is executing the same operations, the sequences of the states of each of the CPUs should be the same after executing the operations without lockstep timing but will be lockstep based on the sequences of instructions.

The monitor system logic may be a hardware processing element that is configured to monitor the state of each of the CPUs independently of each other. In embodiments, responsive to the monitor logic receiving required first data responsive to the first CPU reaching a checkpoint, the first CPU may automatically halt itself, the monitor logic may instruct the first CPU to halt via a pause command to the first CPU. The monitor logic may then assert the halt, which takes control from the CPU (i.e. the CPU stops asserting its own halt signal), and while the first CPU is halted, upon the second CPU reaching the checkpoint, the second CPU may transmit second data to the monitor logic, and automatically halt itself. Responsive to the monitor logic receiving required second data associated with the checkpoint from the second CPU, the monitor logic may instruct the second CPU to halt via a pause command to the second CPU, which takes control from the CPU (i.e. the CPU stops asserting its own halt signal), and assert the halt.

Responsive to the monitor logic receiving required third data associated with the checkpoint from the third CPU, the third CPU may automatically halt itself, and the monitor logic may instruct the third CPU to halt via a pause command to the third CPUwhich takes control from the CPU (i.e. the CPU stops asserting its own halt signal), .

Upon each of the CPUs reaching the checkpoint, the monitor logic may transmit a state request to each of the paused CPUs, and in return independently receive encrypted state data from each of the CPUs. The monitor logic may then decrypt the state data, and compare the state data, which indicates the state of each of the CPUs upon reaching the same instruction in the program – which may occur at different instances of time. If the state data of each of the CPUs is identical, then the monitor logic may determine that there are no faults in the system. If the state data of one of the CPUs is different from the others, the monitor logic may determine that the CPU with the different state data has a fault. In embodiments, a one-way hashing process and/or a symmetric encryption key may be used to generate a representation of the state data to be compared by the monitor logic. In these embodiments, it is possible to detect CPU state differences without the ability or requirement for the monitor logic to decrypt the state data when comparing state data at the checkpoint.

In operation, the CPU with the different state data may be taken offline, and the monitor logic may release the other CPUs (with the same state data) for execution of further programs. When the monitor logic releases its halt to a corresponding CPU, the corresponding CPU resumes execution of subsequent instructions, which may include their own checkpoints.

Whenever an unutilized multiprocessing link is available, for example after a failed CPU has been removed, a new CPU may be installed. Whenever an uninitialized CPU is present within the system, it may optionally be initialized and integrated into the multi-CPU system as an online CPU. To initialize the new CPU, the new CPU may copy the current system state of the online CPUs, while the online CPUs are running. This may degrade the overall redundant system, by requiring shared resources to initialize the CPU to have the same system state as the other online CPUs but allow the system to operate.

Upon there being a valid shared system state between the new CPU and the online CPUs based on the state data that was received by the monitor logic while the online CPUs are halted. Specifically, and the core states of the online CPUs (including their registers, secure enclave control data, and any associated accelerator logic states) may be transferred to the new CPU via the initialization hardware. However, the core states of the online CPUs may contain their private encryption keys for RAM and other sensitive programs. Accordingly, it is required to encrypt the internal core state of the CPUs before transmitting the encrypted internal core state of the CPUS to the initialization hardware. This allows the encrypted internal core state of the CPUs to be decrypted by the new CPU, and load the registers of the new CPU with the decrypted core state. Accordingly, the core state of the new CPU will match the core states of the online CPUs, while the new CPU and the online CPUs are temporarily at halt. Once the core states of all the CPUs are identical, the monitor logic may release the CPUs and all of the CPUs may operate in parallel again. Key distribution for encryption and decryption of data between the multi-CPU environment and the new CPU may be handled as known in the art, for example by One Time Programmable (OTP) key fuses, mask ROM signing keys, Hardware Security Module (HSM) implementations, or any other method of ensuring that only an authorized, verified CPU is able to access the encrypted data produced by the online CPUs. In the event that the new CPU is unable to decrypt the core state data (for example if an unauthorized CPU has been inserted that lacks the correct decryption keys), the control logic will detect the invalid state and reject the new CPU as faulty, thus halting the initialization process with no unauthorized access to sensitive data having occurred.

Furthermore, with recent advancements in multi-CPU, fully redundant, fault-tolerant systems, and specifically in the area of hot swapping / hot inserting CPUs into an active fault-tolerant system, a need to securely authenticate and bring the new CPU(s) online within the system is needed.

However, fault-tolerant systems of this nature generally share system state among all parallel redundant CPUs, and as a result, the shared system state will typically include encryption keys, application privilege levels, user authentication information, and other highly sensitive data. Such data must not only be protected against unauthorized read, but also unauthorized write, as writing to certain locations (e.g. privilege tables) can also enable unauthorized access to the running fault-tolerant system.

Due to the requirement for shared state, without any further security measures taken, it should be apparent that any compatible CPU, or even any device that is able to attach to the fault-tolerant system and emulate a compatible CPU, would gain full access to all data on that system. This presents a serious security risk, as it would be trivial for an attacker to attach a custom, unauthorized hardware device to a running fault-tolerant system and gain access to all data present on and control over the entire system. This risk continues to exist even if the system utilizes standard Root of Trust (RoT) capabilities to secure the initial boot process, since the access occurs post-boot while attaching a new or replacement CPU to the running fault-tolerant system. Similarly, while the fault-tolerant system generally described herein may use encryption to protect the transfer of state to and from the various CPUs in the system, key distribution remains an unsolved problem. Using a mask ROM, OTP, or relying on vendor-controlled signature verification for access to a secure private key still results in a situation where a leak or crack of the underlying private key would result in the ability to compromise multiple (if not all) fault-tolerant systems using that particular type of CPU, as the private key by definition can be used to encrypt and decrypt the shared system state of the parallel CPUs.

To address these security problems, embodiments may leverage specific security technologies heretofore applied to standard non-fault-tolerant systems. In these embodiments, each CPU in the secure fault-tolerant system (SFTS) contains its own FlexVer Hardware Security Module (HSM), and, therefore, its own internal, unique, non-shared private key, which is generated by the HSM itself, using audited HSM firmware, all within in a secure environment, wherein this internal key is never transmitted outside of the HSM.

In embodiments, this internal key is also scrambled on tamper detection and/or power loss. Each CPU also contains the associated public key for that private key, where the public key of each authorized CPU for that particular SFTS is made part of the running system state during the provisioning and/or boot process.

Crucially, the list of authorized CPU public keys is dynamic; wherein individual CPU public keys may be added and removed by authorized users (e.g. system administrators) at any time while the SFTS is in operation. This list may even include known authorized spare parts, for example if an organization has a large SFTS that must be repairable within a given window, spare CPUs may be provisioned and stored associated with the SFTS where the CPU public key is already present within the SFTS authorized CPU list. This may even be extended where the public key of a given spare CPU may be pre-loaded into the authorized CPU lists of multiple SFTS, to allow one CPU to serve as a cold spare for multiple different compatible SFTS as needed, with no other authorization actions required within each SFTS before installation.

Since an external monitor system is used in fault-tolerant operation, and that the external monitor system should remain unable to decrypt the system state while still being able to detect deviations in state on each particular CPU, it is advantageous to retain a shared, symmetric encryption key (“state key”) for state transfer and fault detection across all CPUs in any particular SFTS.

This key is randomly generated during system boot using a secure random number generator, and is distributed only in encrypted form to each CPU in the SFTS using the private and public keys of the HSM resident in each CPU. In embodiments, the master boot CPU (CPU0) generates the state key, and encrypts it with the public key of each authorized CPU present within the SFTS. Each CPU then decrypts the encrypted state key using its own internal private key, and subsequently uses the decrypted state key to encrypt all fault-tolerant state transmissions.

In this manner, embodiments utilize the state key that is not only random between every SFTS, but is also random across each reboot of the system. In embodiments, the state key may also be rotated automatically at any time outside of checkpoint execution, using the same general process of key generation, encryption, transmission, and decryption that is used during the initial boot. For example, state key rotation may occur automatically immediately following each checkpoint comparison. In this manner, the system state key becomes ephemeral, and is practically impossible to crack in a useful manner via any known means. In embodiments, rotation is blocked during checkpoint execution only to prevent a false mis compare in the monitor logic due to the key changing in the middle of an active checkpoint operation. In other embodiments, pipelining, retry signals, handshaking, or other methods known in the art may instead be used to recover from a miscompare, thus allowing key rotation at any time.

It would be apparent to one skilled in the art that this system of key distribution and a random, rotating state key means that it is fundamentally impossible to attach a CPU that does not contain a private key with an associated public key matching the authorized list into any given SFTS. Attempting to do so will result in an inability to decrypt the initial encrypted state key transmission, and subsequent repeated failures to decrypt the encrypted system state transmissions due to a lack of the current state key required for decryption. The monitor logic will subsequently detect the system state mismatch, and disallow the CPU from interacting with the remainder of the SFTS, thus also preventing Denial of Service (DoS) type attacks attempting to utilize the CPU insertion process as an attack vector.

As used herein, the term “CPU state” refers to a defined subset of architectural information associated with a processor that is sufficient to allow correct continuation of program execution from a checkpoint. In embodiments of the present disclosure, CPU state includes architectural information that affects instruction sequencing and externally visible program behavior, including instruction pointer values, register values, processor status and control information, architecturally visible memory contents, and execution mode or interrupt state. CPU state excludes transient microarchitectural information that does not affect architecturally defined program behavior, including speculative execution data, reorder buffers, branch prediction structures, cache replacement metadata, pipeline timing state, and other implementation-specific internal processor mechanisms. Variations in such transient information between processors do not affect correctness provided that architectural equivalence is preserved.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention, and the invention includes all such substitutions, modifications, additions, or rearrangements.

### BRIEF DESCRIPTION OF THE DRAWINGS

Non-limiting and non-exhaustive embodiments of the present invention are described concerning the following figures, wherein like reference numerals refer to like parts throughout the various views unless otherwise specified.

FIG. 1 depicts a topology for a system configured to manage and control data center environments without a shared clock source or varying CPU frequencies, according to an embodiment.

FIG. 2 illustrates a method for securing lockstep execution and automatically detecting errors, according to an embodiment.

FIG. 3 illustrates a method for integrating a CPU into a multi-CPU environment, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted to facilitate a less obstructed view of these various embodiments of the present disclosure.

### DETAILED DESCRIPTION

In the following description, numerous specific details are outlined to provide a thorough understanding of the present embodiments. It will be apparent, however, to one having ordinary skill in the art that the specific detail need not be employed to practice the present embodiments. In other instances, well-known materials or methods have not been described in detail to avoid obscuring the present embodiments.

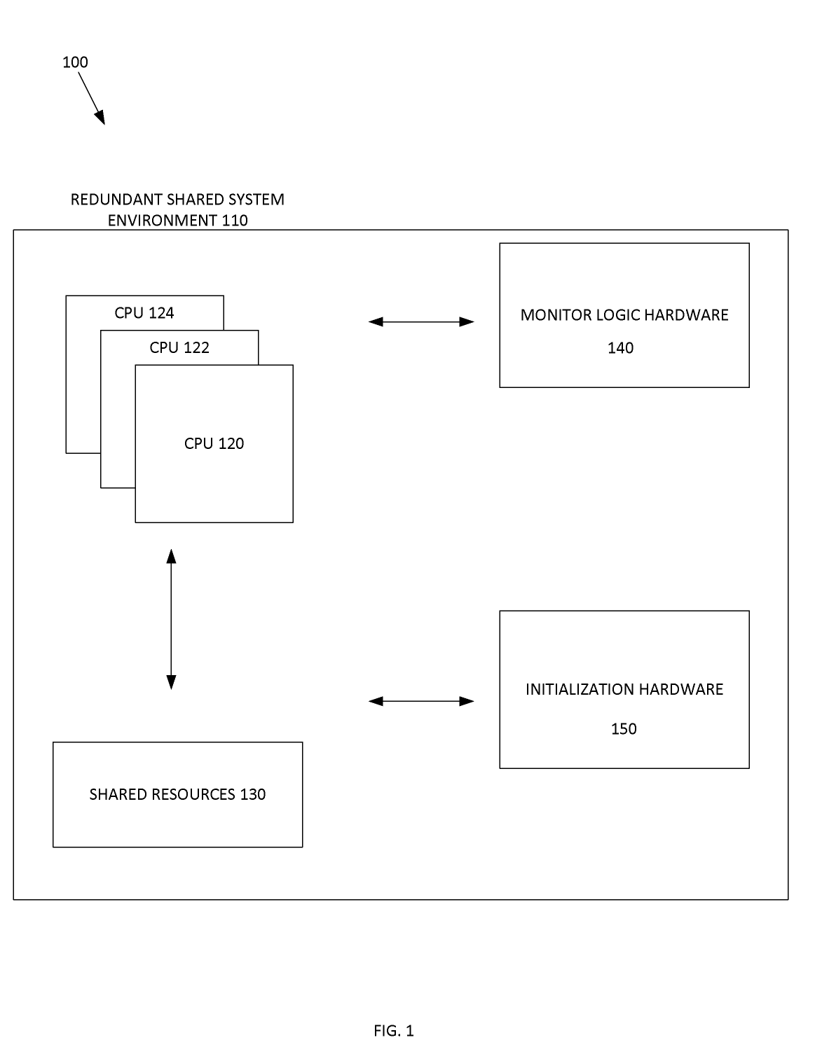

Turning now to FIG. 1, FIG. 1 depicts a topology for a system 100 configured to manage and control data center environments without a shared clock source or varying CPU frequencies, according to an embodiment. System 100 may include a multi-CPU environment 110, monitor logic hardware 140, and initialization hardware 150.

A multi-CPU environment 110 may be a network of computer systems typically used for the storage, processing, or distribution of data. Multi-CPU environment 110 may include a plurality of chassis allowing for high-density computing by providing a centralized power supply, network connections, and cooling systems for all the servers and corresponding CPUs housed within it. Multi-CPU environment 110 may include a plurality of CPUs, including a first CPU 120, a second CPU 122, and a third CPU 124, and shared resources 130.

Each of the CPUs 120, 122, 124 may be a primary processor for a given computer, and is configured to execute instructions associated with a computer program with checkpoints. For example, the computer programs may be associated with firmware, BIOS, arithmetic, logic, controlling, I/O operations, etc. Each of the CPUs 120, 122, 124 may be associated with a server within a multi-CPU environment 110, and may have their own independent clock that regulates the timing and speed of all computer functions for the corresponding CPU 120, 122, 124. While executing the instructions utilizing their independent clocks, each of the CPUs 120, 122, 124 may have a state change that refers to how and where the computer program stores data in variables, which represent storage locations in the computer's memory. The contents of these memory locations, at any given point in the program's execution, are called the program's state. Each of the CPUs 120, 122, 124 includes a large register bank. In operation, the CPUs 120, 122, 124 may be impacted by a change in the CPU’s state that is triggered by an event or input, running software or program, etc. that caused the state change. Because the CPUs 120, 122, 124 run asynchronously with their independent clocks, the state of each of the CPUs may drift apart and be different from each other at a given instance in time. However, because each of the CPUs 120, 122, 124 is executing the same operations, the sequences of the states of each of the CPUs 120, 122, 124 should be the same without lockstep timing. Therefore, the state of each of the CPUs should be the same at any given point in the sequence of a program being run.

More specifically, CPUs 120, 122, 124 in the disclosed system may operate using independent clock sources and are not required to be temporally synchronized. Deterministic equivalence of execution is maintained by enforcing architectural and system-level constraints rather than by cycle-level alignment. Specifically, CPUs 120, 122, 124 execute identical instruction sequences in the same logical order, which may occur at different instances of time.

The checkpoints are configured to interrupt code executions, to allow coordination of the execution of the instructions at different times. As a result, CPUs 120, 122, 124 executing asynchronously may reach corresponding checkpoints at different times while still producing equivalent architectural CPU state. By decoupling temporal execution of the instructions from state equivalence, the system enables validation and error detection to occur at discrete checkpoints without requiring shared clocks, matched frequencies, or cycle-by-cycle comparison.

In embodiments, the CPUs 120, 122, 124 have associated encryption and decryption element and may include a shared secret that is made available to properly authenticated CPUs at startup, reset, hotplug, or any other time CPU state may be flushed. In embodiments, the executed programs may include checkpoints, wherein the checkpoints are specific instructions to transmit the corresponding checkpoint information and data associated with the state of the corresponding CPU 120, 122, 124 to monitor logic hardware 140.

Shared resources 130 may be computing resources that may be utilized by each of the CPUs 120, 122, 124 while running sequences of instructions. For example, the shared resources 130 may include RAM, programs, data, file access, storage devices, peripherals, etc.

Monitor logic hardware 140 may be a hardware computing device configured to communicate with CPUs 120, 122, 124. Monitor logic hardware 140 may be configured to actively observe and analyze the state of each of the CPUs 120, 122, 124, and to issue commands to each of the CPUs 120, 122, 124 independently of each other. For example, monitor logic hardware 140 may issue a command to halt CPUs 120, 122, 124 based on analyzing and/or receiving data from each of the CPUs 120, 122, 124. In implementations, monitor logic hardware 140 may be configured to detect faults within CPUs 120, 122, 124 based on differences in the states of the CPUs when executing programs based on a series of checkpoint transmissions from CPUs 120, 122, 124 to monitor logic 140. The checkpoints may be implemented via several different options and combinations, such as a specific instruction within the program that triggers a checkpoint comparison of the states of the CPUs 120, 122, 124. In embodiments, the specific instruction may be similar to a cache flush, synchronization instruction, etc.

Initialization hardware 150 may be a hardware computing device 150 that is configured to initialize a new CPU to be added to a multi-CPU environment 110 to run in parallel with CPUs 120, 122, 124, and utilize shared resources 130. Initialization hardware 150 completes a series of steps to configure its internal registers, set up memory access, enable interrupts, and prepare the new CPU to execute instructions. In specific embodiments, initialization hardware 150 may be configured to match the core state of the new CPU with the core states of the online CPUs being utilized by data center 110.

In implementations, while CPUs 120, 122, 124 are running programs with checkpoints, upon initiation of the instructions with a checkpoint comparison, the CPUs would automatically synchronize I/O and transmit the required data to the monitor logic hardware 140. In embodiments, the required data may include data associated with the state of the system, data associated with the checkpoint, and identification data. Because each of the CPUs 120, 122, 124 is running asynchronously with their own clock, the monitor logic hardware 140 may receive the required data at different instances of time. In other words, since each CPU may be operating on its own clock source (though this type of independent clocking is not a requirement for the disclosed methods to function), there may be a delay as each CPU independently reaches the checkpoint instruction. Upon receiving the required data from the first of the CPUs 120, 122, 124, monitor logic hardware 140 may begin a state comparison check, or monitor logic hardware 140 may optionally time out one or more CPUs if they do not present the required data within a predetermined timeframe from the first CPU to present the checkpoint data and wait. This option is particularly useful when issued as part of the control program directly before changing the external system state (e.g. control lines to the external process), as it allows the CPUs to run at full speed yet an incipient fault will still be detected and handled before the external process is potentially mis-controlled.

In embodiments of the present disclosure, hardware monitor logic 140 functions as an external authority for coordinating checkpoints, comparing CPUs 120, 122, 124 states, controlling execution progression, and determining if one of the CPUs 120, 122, 124 has a faulty state. While a CPU's 120, 122, 124 may independently assert a halt condition upon reaching a checkpoint, final authority over execution control is assigned to the monitor logic 140. This allows monitor logic 140 to progress the instructions after comparing and validating the state data of CPUs 120, 122, 124 at the checkpoints. This separation prevents race conditions and ensures consistent validation across processors operating asynchronously, while also allowing the synchronization of the initial execution of the instructions at the checkpoints.

In a representative sequence, a processor reaching a checkpoint asserts a provisional halt and transmits corresponding CPU state data to the monitor logic 140. Upon receiving state data from a processor, the monitor logic asserts 140 an authoritative halt condition that prevents the processor from resuming execution until all validation is complete. Following the comparison of the received CPU state data from each of the CPUs 120, 122, 124, the monitor logic 140 selectively releases the halt condition if the equivalence criteria are satisfied.

If a mismatch or fault is detected, the monitor logic 140 maintains the halt condition for each of the CPUs 120, 122, 124 and initiates one or more fault handling actions, including processor isolation, error reporting, or processor replacement. Centralizing halt authority within the monitor logic 140 eliminates reliance on peer-to-peer processor coordination and ensures deterministic fault handling independent of processor clock alignment or execution timing.

In other implementations, the checkpoints may be a hook into an existing instruction for the executed program. For example, a “dcs” or related cache synchronization instruction. This is largely transparent to existing application code and requires no modification to the processor instruction set, however, it gives up the real-time control and extreme reliability aspects of the custom-instruction-based approach above. Upon initiation of the instructions with a checkpoint comparison, the CPUs would automatically synchronize I/O and transmit the required data to the monitor logic hardware 140.

In other implementations, the checkpoint may be a timed request from the monitor logic hardware 140, whereby the CPU with the highest number of cycles executed is halted, its state is transmitted, and the other CPUs automatically halt/transmit state on reaching that cycle count. A similar indicator to CPU cycle count may be used instead. This implementation may allow each of the parallel CPUs 120, 122, 124 to “catch up,” and theoretically reach the same state (if executing normally) before the monitor logic hardware 140 compares the state of each of the CPUs. One skilled in the art may appreciate, using a dedicated checkpointing instruction, or by attaching to an existing data flush instruction, that concerns relating to non-deterministic behavior around memory-based atomic locking (“lwarx/stwcx”) may be bypassed. The same may not be true with time-based checkpointing by default and may require additional modifications to the CPU internal core design to overcome.

To this end, upon a checkpoint being initiated, each of the CPUs 120, 122, 124 transmits their corresponding encrypted state data to monitor logic hardware 140. Upon receiving the state data, monitor logic hardware 140 may transmit a command to a corresponding CPU to halt the corresponding CPU. Upon receiving the state data from each of the CPUs 120, 122, 124 monitor logic hardware 140 compares the state data. If the state data for each of the CPUs 120, 122, 124 is identical, monitor logic hardware 140 may determine that there are no faults. If the state data for each of the CPUs 120, 122, 124 is not identical for all but is for at least two, monitor logic hardware 140 may determine that there is a fault in the non-identical CPU, and the non-identical CPU may be removed from multi-CPU environment 110. Furthermore, monitor logic hardware 140 may transmit commands to release the halt to the other CPUs.

In implementations, all state data is encrypted before transmission to the monitor logic hardware 140, and only CPUs that possess the shared secret can decrypt the state data. Due to specific algorithm selection (i.e., deterministic / stateless algorithms that may be similar to homomorphic algorithms in practice), the monitor logic hardware 140 is still able to compare the state data to determine identical/non-identical without accessing the unencrypted data stream. In preferred embodiments, the monitor logic hardware 140 can perform a simple bitwise comparison of the encrypted state data to determine if the CPU state is identical across the multiple CPUs in the system. This may reduce the complexity of the non-redundant monitor logic and associated failure risk.

In specific implementations, each CPU may be required to authenticate itself on the parallel CPU network before receiving the shared secret (i.e. allowing the remaining functional CPUs to determine if the new CPU is in fact trustworthy / authorized per the application code before accepting it), it should be apparent that other methods of key distribution are applicable, including well-known methods such as OTP shared keys, mask ROM based keys (“vendor signing keys”), etc.

Furthermore, upon removing a CPU from the multi-CPU environment 110, it may be required to reset the removed CPU before reintegration of the CPU to the multi-CPU environment 110 while the remaining CPUs are online, and/or initiate a new CPU to be added to the multi-CPU environment 110 while the remaining CPUs are online.

When a CPU is reset / hot plugged, there is a need to transmit the system state associated with the online CPUs to the new CPU module before the new CPU may begin lockstep execution. Depending on the configuration of the system (i.e. whether each CPU has its associated copy of system memory or if a shared memory controller is used), this transfer of state associated with the online CPUs may require significant time. Furthermore, in the case where a shared I/O controller is not used (i.e. where each CPU is directly controlling attached peripherals on a shared bus), it may be necessary to run various startup and link training routines to bring the associated I/O controller(s) online.

In recognition of these difficulties, a multi-stage startup process is desirable for new CPUs that include internal RAM and/or I/O controllers. This multi-stage process may not apply to CPUs that use a shared bus, for example (but not limited to) a coherent SMP bus, for all memory and I/O controller access (“Simple Cores”). For these types of CPU, a firmware or similar program (“initialization/bringup program”) needs to run first to configure the memory and I/O controllers for the new CPU, as well as transfer memory contents from the online CPUs to the new CPU before the new CPU using the initialization procedure (below) at the point of final activation, which may be completed by initialization hardware 150.

Memory transfer in particular may be challenging, as a large amount of data may need to be transmitted; in the preferred embodiment, coherent SMP/DMA style “write broadcast” updating as known in the art for inter-CPU synchronization is used to avoid a need to halt the functional CPUs for an extended period of time, with a simple memory copy loop running as part of the bringup program on the new CPU for bulk data transfer. Once transfer is complete, coherence is maintained via the same SMP-type “write broadcast” mechanism until the new CPU is activated and starts operating in parallel mode. This method of transfer will impose a performance penalty on the operation of the existing cores during transfer and before the new CPU is activated, but conversely will not cause the system to drop offline for long amounts of time while the new CPU is being activated. It is also possible to simply halt the existing cores at the point of activation per the initialization process (below), and copy the contents of RAM using the new CPU’s initialization prior to transferring state and activating the new CPU.

In embodiments, initialization hardware 150 may be configured to begin the initialization process by monitor logic hardware 140 transmitting commands to halt the remaining online CPUs at the next checkpoint. Upon reaching the next checkpoint, the remaining online CPUs may transfer their state to the new CPU. Once the newly added CPU indicates that the state has been received and loaded, all CPUs are released from halt and execution continues with the newly added CPU now in lockstep with the other parallel CPUs. In such situations, The hardware monitor logic 140 may include a timeout such that the CPUs are not halted for an extended time period if the newly added CPU is faulty or does not otherwise come online within a predetermined amount of time.

A final challenge to overcome is the set of instructions in newer CPUs that return non-deterministic results by design, for example, random number generation (“darn” and similar) instructions. In the preferred embodiment, each lockstep CPU votes or otherwise becomes the “master” for such operations (for example, under the operation of the monitor logic), and the result of said operation is transmitted to the other parallel CPUs. While there is a performance penalty for this type of operation, given the relative rarity of such operations the penalty is unlikely to be significant or even detectable in real-world operations. If the performance penalty of this type of operation is important to the end application, the CPU design could include a random number generation unit that to synchronize with identical random number generation units in other CPUs (i.e. over the encrypted state transfer link), and thus produce the same results when accessed in the same sequence by each of the synchronized CPUs.

It should be noted that the methods above apply to multi-core (SMP) systems as well as single-core CPUs and that there is no restriction on the type of communication or bandwidth between the parallel lockstep CPUs. For example, in one embodiment three CPU packages, each containing a set of SMP CPUs, may be interconnected to a shared OMI and OpenCAPI network for memory and I/O access, respectively, with state data transmitted to the external monitor logic 150 over a variant of OMI. Such a system 100 would allow failure and hotswap of a single CPU package without interruption of the system 100, and due to the use of OMI/OpenCAPI the CPU packages may not even be located in the same physical chassis, but rather be interconnected between chassis units via fiber optic link, high-speed copper link, or similar.

In another embodiment, three Arctic Tern D-DIMM modules are used, each with its own CPU core, I/O controller, and associated on-board RAM, with the interconnect to the external monitor device consisting of standard SERDES. In this embodiment, the primary control outputs from each D-DIMM module are serial and logic level control signals, and in the preferred embodiment, these signals are arbitrated / pass through the monitor logic device to allow full isolation of a malfunctioning D-DIMM module.

In another embodiment, each CPU package contains multiple CPUs in a coherent SMP arrangement, as well as a memory controller that is shared between those CPUs. This provides significant memory redundancy (equal to the number of CPU packages) without the excessive cost of providing independent RAM to each CPU. In this embodiment, the initialization does not need to run as long as the package itself is not removed / replaced / reset, and may in fact run on an independent initialization hardware 150 included in the CPU package. This embodiment provides significant advantages in that it is possible to fault and replace the RAM and/or the CPUs associated with a specific CPU package without deactivating the overall system, while also not requiring duplication of the entirety of system RAM for each individual CPU in said overall system 100.

Furthermore, anyone skilled in the art may appreciate that the hardware monitor logic 140 can be customized for specific applications and may be configured to take various actions in the case of detected faults, for example to automatically reset failing CPUs, and/or to isolate malfunctioning CPUs, and/or to raise external alarms. Similarly, it is possible for a CPU to detect various faults in its own operation or in associated subsystem operation as known in the art (EEH/RAM EDAC/predictive GUARD, etc.) and explicitly request that it be removed from operation or reset by the monitor logic, potentially providing a fault description or similar data in the process, or even for an external monitor system to automatically pull fault data from each associated device and instruct hardware monitor logic 140 to fault out the associated CPU(s). Such obvious control system improvements as known in the art remain within the scope of this disclosure, even if not specifically called out above.

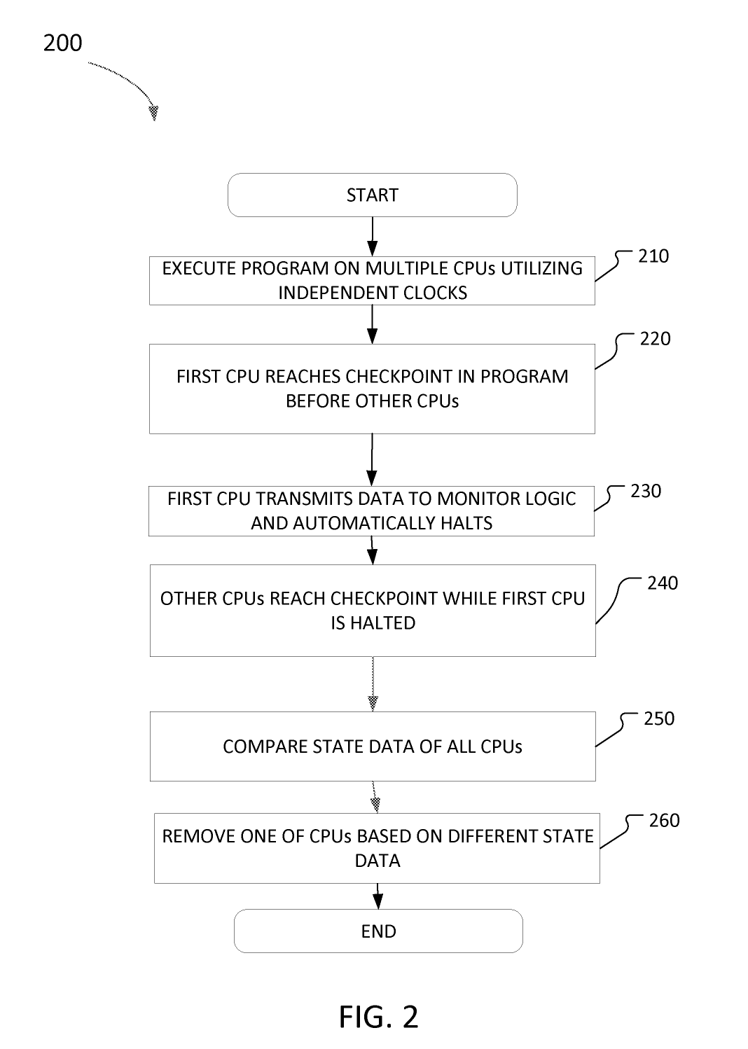

FIG. 2 illustrates a method 200 for securing lockstep execution and automatically detecting errors, according to an embodiment. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a solid-state machine, reconfigurable logic, fixed logic, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At operation 210, a plurality of CPUs may be executing the same set of instructions asynchronously using independent clocks. This may cause the state of each of the CPUs to be different at any given instance of time but should be the same at a given sequence of the instructions. In other words, each processor independently executes the identical sequence of instructions until reaching a defined checkpoint, wherein the checkpoint corresponds to a deterministic execution boundary at which architectural CPU state is fully committed. The processors may reach the checkpoint at different times due to asynchronous operation.

At operation 220, while executing the same sets of instructions a first of the CPUs may reach a checkpoint within the instructions.

At operation 230, responsive to reaching the checkpoint, the first CPU may capture the architectural state of the first CPU, wherein the state of the first CPU is sufficient to permit continuation of execution of programs. The first CPU may then transmit data to hardware monitor logic, automatically halt itself, and the monitor may assert a halt. While the first CPU is in halt, the other CPUs may continue to run the set of instructions. In embodiments, the transmitted data may include state data associated with the first CPU, which may be encrypted.

Specifically, The CPU automatically halts itself when the checkpoint is hit, to avoid unwanted execution in the time it takes for the monitor to respond. The monitor then asserts halt, which takes control from the CPU (i.e. the CPU stops asserting its own halt signal), and when the monitor then releases its halt the CPU resumes execution.

At operation 240, the other online CPUs may continue to execute the same sets of instructions until they reach the checkpoint within the instructions. At that point, responsive to reaching the checkpoint, a corresponding CPU may transmit data to hardware monitor logic, and in return receive a halt command. This may continue until each of the CPUs receives a halt command. In other embodiments, the hardware monitor logic may transmit a command to receive the state data associated with each of the CPUs upon the hardware monitor logic receiving an indication that each of the CPUs has reached the checkpoint.

At operation 250, the hardware monitor logic may compare the received state data of each of the now halted CPUs, wherein the comparison is performed at the checkpoint and is independent of the timing at which the processors reached the checkpoint.

At operation 260, if the state data of one of the CPUs is different from the others, the hardware monitor logic may determine that the state data of that CPU is faulty. The CPU with the faulty state data may be removed from the data center. Furthermore, the monitor logic may release the other CPUs from halt, which may allow the remaining CPUs to execute operations. Alternatively, If the CPU state from the processors satisfies an equivalence criterion, the hardware monitor logic releases the authoritative halt condition, thereby permitting each of the processors to resume execution of the program or set of instructions from the checkpoint.

Execution of the identical instruction sequences, programs, code, etc. may continue through subsequent checkpoints under control of the hardware monitor logic, thereby enabling detection of transient or permanent faults without requiring shared clocks, synchronized execution timing, or cycle-by-cycle state comparison.

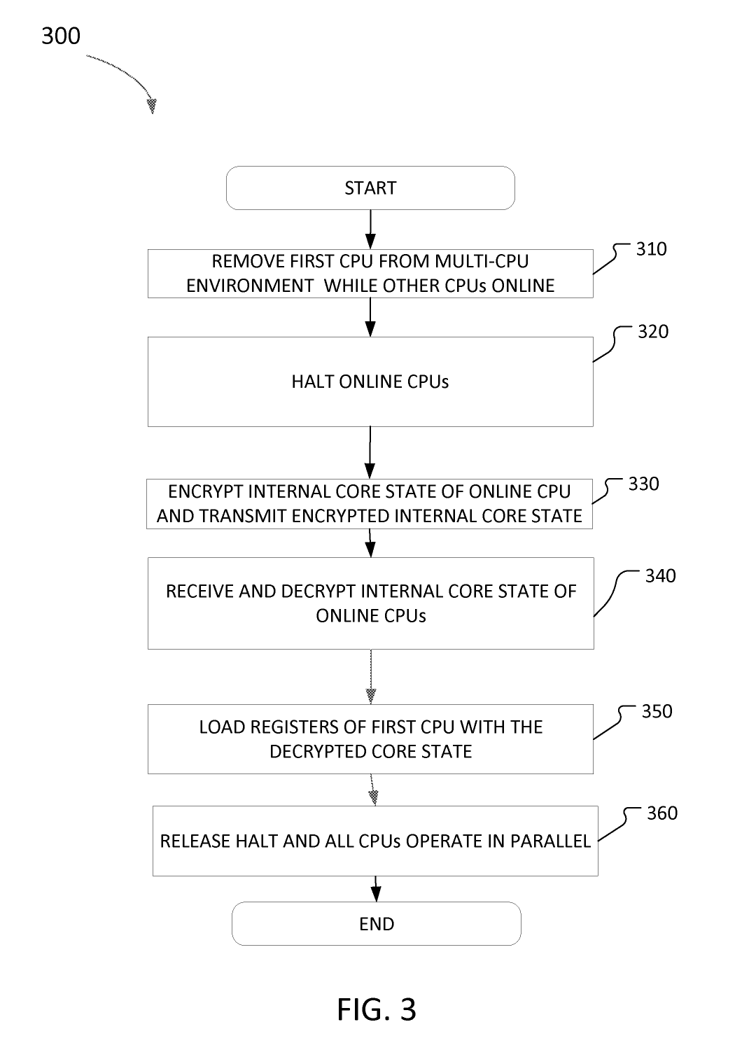

FIG. 3 illustrates a method 300 for integrating a CPU into a multi-CPU environment, according to an embodiment. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a solid-state machine, reconfigurable logic, fixed logic, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 200.

At operation 310, a CPU with faulty state data may be removed from a chassis of a datacenter.

At operation 320, CPUs with identical state data that are online may receive a halt command.

At operation 330, the internal core states of the online CPUs may be encrypted, and transmitted to an initialization hardware. In embodiments, the internal core state of each of the online CPUs may include a shared secret – such as private keys, so security concerns may arise if the internal core state is not encrypted.

At operation 340, the initialization hardware may receive the encrypted internal core states of the online CPUs, and decrypt the internal core states.

At operation 350, the registers of the new – offline – CPU may be updated with the decrypted core states of the online CPUs.

At operation 360, once the newly added CPU indicates that the state has been received and loaded, all of the CPUs are released from halt, via commands from the monitor logic, and execution continues with the newly added CPU now in lockstep with the other parallel CPUs.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to "one embodiment", "an embodiment", "one example" or "an example" means that a particular feature, structure or characteristic described in connection with the embodiment or example is included in at least one embodiment of the present invention. Thus, appearances of the phrases "in one embodiment", "in an embodiment", "one example" or "an example" in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable content may be utilized. For example, a computer-readable medium may include one or more of a portable computer diskette, a hard disk, a random access memory (RAM, DRAM, Flash, MRAM, etc.) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system for securing lockstep execution and automatically detecting errors, the system comprising:
a first set of instructions with a first checkpoint, the first set of instructions being part of an executed program;
hardware monitor logic;
a first CPU with a first clock, the first CPU being configured to execute the first set of instructions until the first checkpoint, upon reaching the first checkpoint the first CPU is configured to assert a first halt automatically, and the first CPU is configured to transmit first data to the hardware monitor logic, wherein the first data includes first state data associated with the first CPU;
a second CPU with a second clock, the second CPU being configured to execute the first set of instructions until the first checkpoint, upon reaching the first checkpoint the second CPU is configured to assert a second halt automatically, and the second CPU is configured to transmit second data to the hardware monitor logic, wherein the second data includes second state data associated with the second CPU, wherein the hardware monitor logic is configured to compare the first data and the second data.

2. The system of claim 1, further comprising:
a third CPU with a third clock, the third CPU being configured to execute the first set of instructions until the first checkpoint, upon reaching the first checkpoint the third CPU is configured to assert a third halt automatically, and the third CPU is configured to transmit third data to the hardware monitor logic, wherein the third data includes third state data associated with the third CPU.

3. The system of claim 2, wherein the hardware monitor logic is configured to compare the first data, second data, and third data.

4. The system of claim 3, wherein when the first data and the second data match and the third data is different from the first data, the hardware monitor logic is configured to determine the third CPU is faulty.

5. The system of claim 4, wherein the hardware monitor logic is configured to transmit a release command to the first CPU and the second CPU upon determining that the first data and the second data match.

6. The system of claim 5, wherein the third CPU is removed from the system.

7. The system of claim 2, wherein the hardware monitor logic is configured to transmit a first pause command to the first CPU in response the hardware monitor logic receiving the first data, the hardware monitor logic is configured to transmit a second pause command to the second CPU in response the hardware monitor logic receiving the second data, wherein the hardware monitor logic is configured to transmit a third pause command to the third CPU in response the hardware monitor logic receiving the third data.

8. The system of claim 7, wherein the hardware monitor logic is configured to receive the first data, second data, and the third data in response to transmitting each of the first pause command, second pause command, and the third pause command.

9. The system of claim 2, wherein the first clock is running asynchronously with the second clock.

10. The system of claim 9, wherein sequences associated with the first state data and the second state data are identical without lockstep timing of the first clock and second clock.

11. The system of claim 2, further comprising:
initialization hardware configured to initialize a fourth CPU to run in parallel with the first CPU, second CPU, and third CPU, wherein the initialization hardware is configured load a core state of the fourth CPU with an identical core store of the first CPU at the first checkpoint.

12. The system of claim 11, wherein the core state of the fourth CPU is installed before the first CPU and the second CPU execute a second set of instructions.

13. The system of claim 2, wherein the first CPU, second CPU, and third CPU reach the first checkpoint at different periods of time while executing the first set of instructions.

14. The system of claim 2, wherein the first CPU, second CPU, and third CPU share an encryption key, wherein the encryption key is utilized the encrypt the first data, second data, and third data before the first data, second data, and third data is transferred to the hardware monitor logic.

15. The system of claim 14, wherein the hardware monitor logic does not have access to the encryption key.

16. The system of claim 15, wherein the hardware monitor logic compares the encrypted first data, encrypted second data, and encrypted third data without decrypting the encrypted first data, encrypted second data, and encrypted third data.

17. The system of claim 1, wherein the first set of instructions with the first checkpoint includes a plurality of embedded checkpoints, wherein each of the plurality of embedded checkpoints are known points in program execution of the first set of instrucitons.

18. The system of claim 17, wherein the first CPU and the second CPU share computing resources, including RAM and storage devices, without requiring an exlsuive lock on the shared resource.

19. The system of claim 17, each of the plurality of embedded checkpoints trigger a series of events to detect errors and allow for new CPUs to be integrated into a multi-CPU environment.

20. The system of claim 17, wherein the first CPU and the second CPU are configured to execute a second set of instructions with its own checkpoints after executing the first set of instructions.
